(19) United States
(12) Patent Application Publication
(10) Pub. No.: US 2002/0087334 A1
(43) Pub. Date: Jul. 4, 2002

(54) Removable digital storage media rental

(76) Inventors: Shin Yamaguchi, Newport Beach, CA (US); Hideo Mizoguchi, Kawasaki (JP); Royce E. Slick, Mission Viejo, CA (US); Don Hideyasu Matsubayashi, Monterey, CA (US)

Correspondence Address: FITZPATRICK CELLA HARPER & SCINTO, 30 ROCKEFELLER PLAZA, NEW YORK, NY, 10112, US

(21) Appl. No.: 09/750,167

(22) Filed: Dec. 29, 2000

(51) Int. Cl. G06F 17/60

(52) U.S. Cl. 705/1

(57) ABSTRACT

A method of renting removable digital storage media for use with a digital image acquisition device includes the steps of loaning removable digital storage media to a customer for storing digital image data captured by a digital image acquisition device, receiving, upon return, the removable digital storage media from the customer and maintaining information associated with the loan and return of the removable digital storage media and the customer.

### BACKGROUND OF THE INVENTION

1. Field of the Invention

The present invention relates to the rental of digital storage media, and more particularly to the rental of removable digital storage media for use in digital image acquisition devices.

2. Description of the Related Art

Digital image acquisition devices, such as digital video cameras, digital still frame cameras and scanning devices, are being used more frequently as digital image photography is becoming more popular. scanning devices are becoming quite commonplace to generate digital images from hardcopy images (e.g., photographs or other print images), and digital cameras are quickly becoming popular alternatives to traditional film cameras. With the rapid advancement of digital technologies, the quality of images produced by these devices have reached a high level of quality. Images produced by digital cameras, for example, are fast approaching those produced by standard film cameras. In addition, images stored in a digital format provide versatility and conveniences such as image processing and sharing capabilities available through the use of computer systems. The digital technology advancements combined with the versatility afforded by the use of digital image data make digital image acquisition devices attractive for a variety of uses.

With each new generation of digital image acquisition device, the ability of the device (e.g., camera) to capture accurate colors and tones in higher resolutions improves the quality of the images captured by the device. However, along with these improvements in the quality of the captured image comes an increase in the amount of data needed to define the image, and a need for more storage space to hold the image data. Typically, a digital camera, for example, stores captured images on removable storage media such as smart media, compact flash cards, and IBM micro-drives, which are inserted into the camera. Technological advancements in these types of storage media have increased the capacity of the media, providing the needed space to store higher quality images as well as a larger number of images on the media. But, along with this increase in capacity has come an increase in the price of the media. The cost of such media is such that users forego purchasing additional storage and elect instead to periodically offload captured images to personal computer storage or some other form of digital data storage.

In the case of a digital camera, once some number of images have been captured, the camera must be connected to a personal computer using a serial cable, Universal Serial Bus, or other similar means, and the pictures offloaded from the camera's storage media onto the personal computer for further processing. In the alternative, the storage media might be removed from the camera and inserted into another device connected to a personal computer allowing the images to be offloaded from the storage media. Offloading the images allows for the image data contained in the removable storage media to be cleared so that the storage media can be used to store additional images captured by the digital camera.

However, situations arise where the number of photographs to be taken in a certain period of time exceed the capacity of the storage media used in the digital camera. Such situations might include family vacations or special events. A digital camera user in one of these situations can either bring a personal computer along in order for the images to be offloaded as the storage media is filled up, or the user can bring multiple storage media along and wait until they return home or to the office to offload the images from all the storage media at once. However, neither of these options may be possible for some users. A user may not have access to a personal computer at times when there is a need to clear the removable storage media. Additionally, given the expense of purchasing additional storage media, it might not be practical or even possible for some users to purchase multiple storage media for an event or situation that is not a common occurrence. Even if a user is able to purchase multiple storage media, since it is generally not acceptable to return purchased media after it has been used for some period of time, unless it is defective in some manner, the additional storage media purchased for this single use may never be needed again once the event has passed.

Certain industries have provided for the temporary use of certain products for a limited amount of time. Movie rental companies, for example, provide a way for consumers to rent a videotape or DVD containing a movie for a period of time, thereby allowing the consumer to view the movie as many times as desired during that time and then return the videotape or DVD. Most consumers do not wish to pay the full price for a copy of a movie in order to view the movie only a couple of times. Another example of a rental solution is provided by car and truck rental services. It would be impractical for an individual to purchase a truck where it is only needed for a limited amount of time (e.g., a weekend move). Instead, the truck may be rented by the individual and returned to the rental service once it was no longer needed. It is also possible, in the case of a car and truck rental, for a customer to rent the vehicle in one location and return it to a different location.

Applicants are not aware of any rental schemes for the rental and temporary use of removable digital storage media. Rental of removable digital storage media presents some unique concerns and difficulties not encountered or addressed by the movie and vehicle rental schemes. For example, removable digital storage media is to be used to store data such as digital image data. When the rented storage media is no longer needed and is returned, the user will want access to the image data on the rented storage media for further processing (e.g., image editing and printing). Further, the image data that has been stored on the returned storage media may be of a sensitive nature, either confidential or personal to the renting user. Measures should be taken to ensure that this data is not accessible to a later renter of the same storage media. Finally, most of the forms of storage media, whether it be smart media, compact flash cards, or some other form, are highly susceptible to damage. Given that the data that is to be captured using a digital camera may be a once-in-a-lifetime occurrence, extra care must be taken to ensure the integrity of the storage media prior to renting it to a customer. Thus, it would be beneficial to have a rental mechanism whereby removable digital storage media may be made accessible temporarily for purposes of storing image data such as that captured by a digital image acquisition device.

### SUMMARY OF THE INVENTION

The present invention addresses the foregoing problems and concerns the rental of removable digital storage media. According to one aspect of the invention, removable digital storage media is rented to a customer, who returns the removable digital storage media to the rental location after using it to store digital image data using some type of digital image acquisition device, such as a digital camera. The rental location keeps track of the rental by maintaining information associated with the removable digital storage media that was lent out and the customer who rented the storage media. The invention thereby allows a customer to temporarily use removable digital storage media when a need arises without having to purchase the storage media.

According to another aspect of the invention, removable digital storage media is rented to a customer who returns it to the rental location after storing digital data on the storage media. When the storage media is returned to the rental location the digital data contained on the storage media is processed. The rental location keeps track of the rental by maintaining information associated with the removable digital storage media that was lent out and the customer who rented the storage media. By processing the digital data contained on the returned storage media, the rental location can provide the customer access to their digital data after the storage media has been returned, ensure the digital data is removed so that a later customer will not have access to it, and ensure the storage media is functional for future use.

This brief summary has been provided to aid in a quick understanding of the present invention. A more complete understanding of the invention can be obtained by reference to the following detailed description of the preferred embodiments thereof in connection with the attached drawings.

### BRIEF DESCRIPTION OF THE DRAWINGS

FIG. 1 is an outward view of representative hardware embodying the present invention.

FIG. 2 is a block diagram representing the internal architecture of a personal computer for use in the present invention.

FIG. 3 is a block diagram representing the system for renting removable digital storage media according to the present invention.

FIG. 4 is a flowchart describing the process of renting removable digital storage media according to the present invention.

FIG. 5 is a representation of a user interface for interacting with the rental system according to the present invention.

FIG. 6 is a flowchart describing the balancing of inventory within the rental system according to the present invention.

### DETAILED DESCRIPTION OF THE PREFERRED EMBODIMENTS

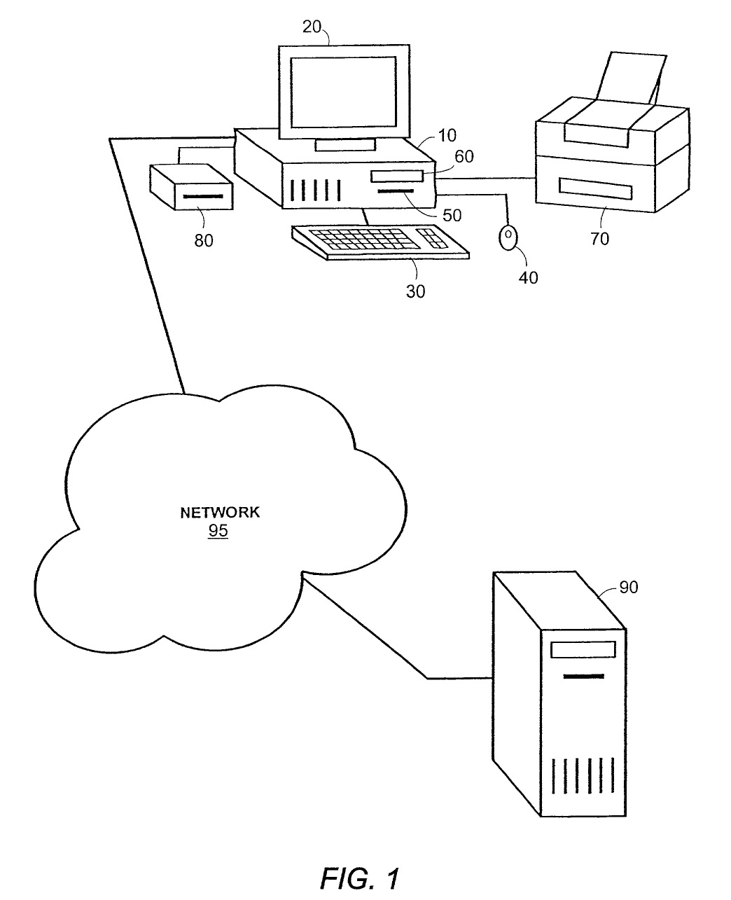

FIG. 1 is an outward view of representative hardware embodying the present invention. Shown in FIG. 1 is a personal computer (PC) 10 executing an operating system such as Windows 98 as well as other software applications, monitor 20 for displaying images and text, keyboard 30 for inputting text into PC 10, and mouse 40 for selecting items displayed by monitor 20. Installed within PC 10 are hard disk 175 (not shown), floppy disk drive 50, and compact disc (CD) drive 60, which has the capability to both read data from and record data on CDs.

Attached directly to PC 10 is printer 70, which has the capabilities of generating photoquality prints of image data. Also attached directly to PC 10 is media processor 80. Media processor 80 accepts removable digital storage media, such as smart cards and compact flash cards, and allows a user to read and transfer data stored on the storage media using PC 10. In addition, media processor 80 has the capability of writing to storage media inserted therein using PC 10. PC 10 is also connected to server 90 via network 95, which may include a local area network (LAN) or the Internet, using a modem connection or a high-speed connection such as a digital subscriber line (DSL), cable or T1.

Server 90 is a personal computer, workstation or network server executing an operating system such as UNIX or Microsoft's Windows operating system (e.g., Windows NT, 2000, 98, etc.) as well as network management utilities and other software applications.

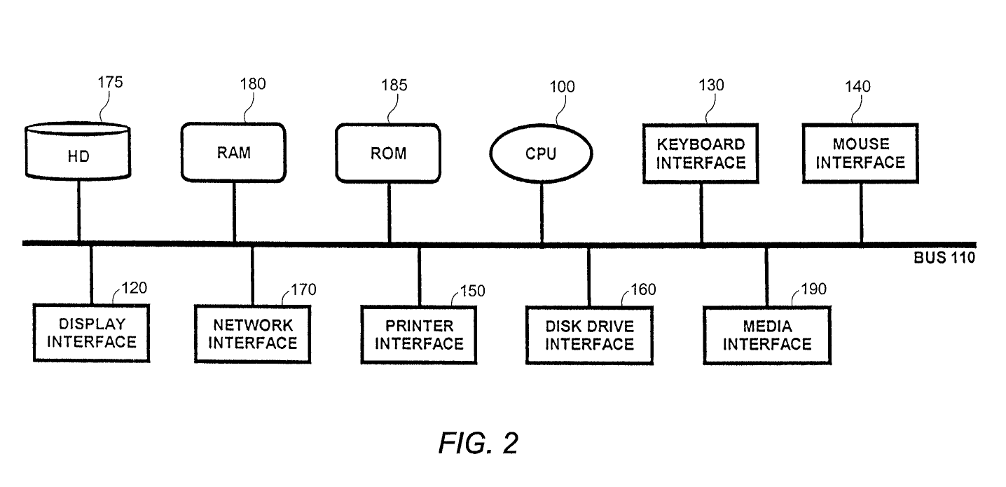

FIG. 2 is a block diagram representing the internal architecture of PC 10. Shown in FIG. 2 is CPU 100 that is connected to bus 110. Also connected to bus 110 are display interface 120 for interfacing with monitor 20 to display text and images generated by PC 10, keyboard interface 30 for interfacing with keyboard 30 to receive text and commands, mouse interface 140 for interfacing with mouse 40 to receive input from mouse 40 including pointing information for selecting items displayed by display monitor 20, printer interface 150 for interfacing with printer 70 to send print data and commands, and disk drive interface 160 for interfacing with floppy disk drive 50 and CD drive 60.

Network interface 170 allows PC 10 to be connected to network 95. The connection may be via a modem (not shown) such as a V.90, cable or DSL modem, for Internet connections, or it could be via a network interface card (not shown) for Ethernet on a private network.

Hard disk 175 stores an operating system, applications, data, and device drivers. Random access memory (RAM) 180 provides temporary storage space for CPU 100 to transfer data and instructions from hard disk 175 to carry out operations and processing needed within the operating system and applications.

Read only memory (ROM) 185 stores process steps needed by PC 10 upon start up and for basic I/O functions such as recognizing keystrokes from keyboard 30.

Media interface 190 provides an interface for PC 10 to perform processing and data transfer with removable digital storage media. Media interface 190 may consist of a serial port, USB port, or other means allowing connection to media processor 80. In the alternative, media interface 190 may allow direct connection to a digital image acquisition device, such as a digital camera, thereby allowing processing and data transfer directly from the digital image acquisition device.

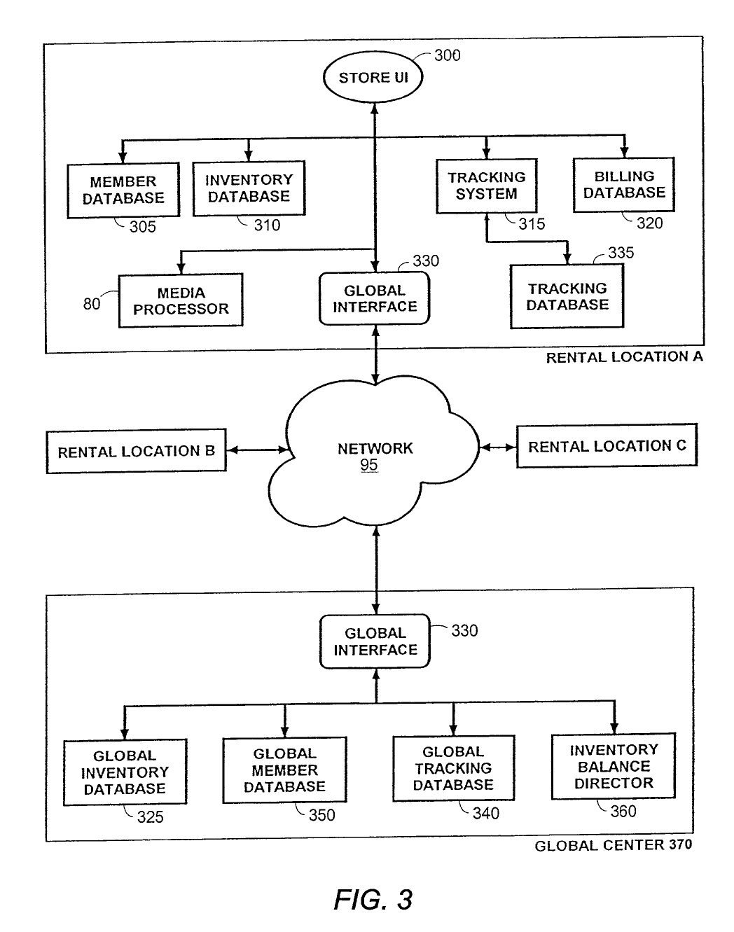

FIG. 3 is a block diagram representing a system for renting removable digital storage media. Shown in FIG. 3 are rental location A, rental location B and rental location C interconnected via Network 95. Rental locations A, B and C have the same structure, a detailed description of which is provided with reference to location A.

Rental location A contains a store user interface (UI) 300, which allows interaction with the rest of the rental system. In this embodiment, store UI 300 consists of display screens that are displayed using monitor 20. Keyboard 30 and mouse 40 may be used to enter data via store UI 300. A customer or employee can use store UI 300 to rent, return and process removable digital storage media. The rental, return and processing of the removable digital storage media will be explained in more detail below.

Rental location A also contains a number of databases utilized in the rental of storage media that are stored on hard disk 175 within PC 10, or another computing system interconnected with PC 10. The databases are implemented using any of a number of available database management systems. The present invention is described herein using a database and database management system. However, it should be apparent that other data storage and management systems may be used with the present invention. The contents of the various databases will now be described, and an explanation of their interaction is described in more detail below.

Member database 305 contains profiles of customers of the rental system. Information contained in a customer's profile may include the customer's name, address, phone number and information pertaining to a rental security deposit (e.g., credit card number). A customer's profile may be accessed by name, phone number, or by a unique identification code assigned to the customer upon creation of a profile. Additionally, other information may be stored in the profile such as special instructions for dealing with that particular customer (e.g., preferences for types of media rented, additional deposit required prior to rental, etc.).

Inventory database 310 contains profiles of the removable digital storage media available for rental from rental location A. Information contained in a storage media profile might consist of an identification code for the storage media, type and capacity of the storage media and some measure of the life of the storage media.

Each storage media can be identified by the identification code which is affixed in some manner to the storage media and listed in the storage media profile. In order to prevent fraud or confusion in the process of renting storage media, the storage media may be marked with the identification code in a manner that cannot be modified or removed by a renting customer. For example, the identification code could be etched into the surface of the packaging of the storage media. An alternative might be storing the identification code, possibly at time of manufacture, in a section, or sector, of the memory of the storage media that is not accessible or alterable by rental customers. The section containing the identification code is protected from erasure or reformatting by unauthorized personnel, and is preferably encrypted for additional security.

Tracking system 315 uses tracking database 335 to store information related to rental transactions. The information stored includes information associated with customers that are currently renting storage media, the particular storage media rented by each customer, and the date the rented storage media are due to be returned.

Billing database 320 stores information related to the charges associated with the rental of storage media. Such information includes rental costs associated with each type of media as well as any late fees incurred by particular customers during previous rentals.

Rental location A also contains global interface 330, which allows rental location A to communicate with other rental locations and global center 370 via network 95. Global interface 330 consists of network interface 170 and a firewall that protects access to rental location A through network 95.

Also contained within rental location A is media processor 80. Media processor 80 allows rental location A to access data contained on returned storage media and process the storage media for further rental. The processing of the storage media will be explained in greater detail below.

Global center 370 is implemented by a computer system such as server 90 and is connected to network 95 using global interface 330. Global center 370 comprises global databases and an inventory balancing application. Three global databases contained within global center 370 are global inventory database 325, global member database 350 and global tracking database 340. These databases operate in a manner similar to that described with reference to the rental locations, with an exception being that the global center databases contain the information relevant to each database for all of the rental locations. It is, however, possible for each of the rental locations to include information associated with one or more other rental locations.

Additionally, global center 370 contains inventory balance director (IBD) 360. IBD 360 maintains the balance of inventory among the various rental locations by referring to the inventory database of each store. The balancing process will be more fully explained below.

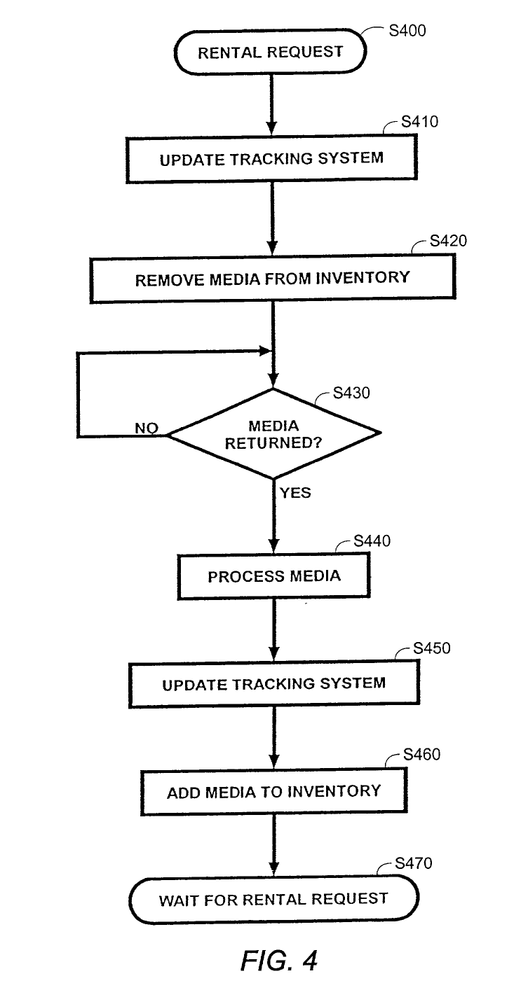

The rental process will now be explained in greater detail referring to the flowchart displayed in FIG. 4.

At step S400 a rental request is made at a rental location by a customer. At this point, tracking system 315 is accessed using store UI 300 to record the transaction. The requesting customer provides the rental location with identification information allowing the rental location to access the customer's profile in member database 305. If the customer is a new customer, a profile may be created at this time by the rental location using store UI 300.

Alternatively, in a global rental system, the rental location may not have a member database 305 at their location, but may instead access global member database 350 via network 95. Another option might include transferring information contained in member database 305 of one rental location to member database 305 of another rental location via network 95. This way a customer's profile will be accessible by any rental location without having to enter the customer's profile at each individual rental location.

At step S410, tracking system 315 updates tracking database 335 with information regarding the rental to the requesting customer. Tracking system 315 maintains an association between the customer and the storage media that is rented by the customer. For example, the customer's profile is associated with the profile of the rented removable storage media by tracking system 315 and stored in tracking database 335. A return date is then added to the entry in tracking database 335. Additionally, billing database 320 is accessed to determine the cost of the rental and whether the particular customer has any outstanding fees owed.

At step S420, the storage media profile is removed from inventory database 310 of the rental location. At this point, the profile of the rented storage media is stored in tracking database 335 by tracking system 315 along with the profile of the renting customer. Accordingly, profiles of storage media that are available for rental from the rental location are stored in inventory database 310 and profiles of rented storage media are stored in tracking database 335. Alternatively, instead of removing the storage media profile from inventory database 310 the storage media profile may be retained by inventory database 310 with an entry indicating its rental status.

Like member database 305, information contained in inventory database 310 may be transferred between rental locations via network 95, or inventory database 310 can be removed from the rental location, and global inventory database 325 accessed via network 95. In such a case, the rental location where the particular storage media is currently located must be identified in the storage media's profile. In this way, rental locations can determine what inventory they have available for rental when referring to global inventory database 325.

At step S430, the rental location awaits the return of rented storage media. The rented storage media may be returned to a rental location other than the location at which the storage media is rented. Where the customer's information is not contained in the return location's member database 305, global member database 350 or member database 305 of another rental location may be accessed via network 95 to retrieve customer information. Alternatively, a token supplied to the customer and containing customer information may be returned along with the rented storage media. The token may be a smartCard, magnetic strip card, USB secure token, etc. The token may contain customer and storage media information for use in identifying the customer and serial number of the storage media rented by the customer. Alternatively, a protected area of the storage media may contain customer and media information which is preferably encrypted to maintain the security of the information.

When storage media is returned by a customer, the media is processed in step S440. Processing includes processing the data contained on the storage media as well as preparing the storage media for a later rental. Processing will be discussed in more detail below.

At step S450, tracking database 335 is updated by tracking system 315 to indicate that the storage media has been returned. For example, the returned storage media's profile in tracking database 335 is updated to reflect a return date. Tracking system 315 ensures that the storage media was returned on time. If the return is late, the late charge and the customer that incurred the charge are entered into billing database 320 by tracking system 315. Once the return time has been checked, the customer's profile and the storage media's profile are removed from tracking database 335 by tracking system 315.

At step S460, the profile of the returned media is entered into inventory database 310 of the rental location where the storage media is returned. As can be seen from the above description, the rental media can be rented at one location and returned to another location. By removing the storage media's profile from the inventory database of one rental location upon rental and adding the storage media's profile to the rental location that receives the storage media, the location of the individual rental storage media can be followed. Alternatively, where the storage media's profile remains in the rental location's inventory database 310 with a status indicator, the status may be updated, or the storage media's entry removed, to reflect a return to another location.

Finally, in step S470, the rental location waits for another rental request by a customer.

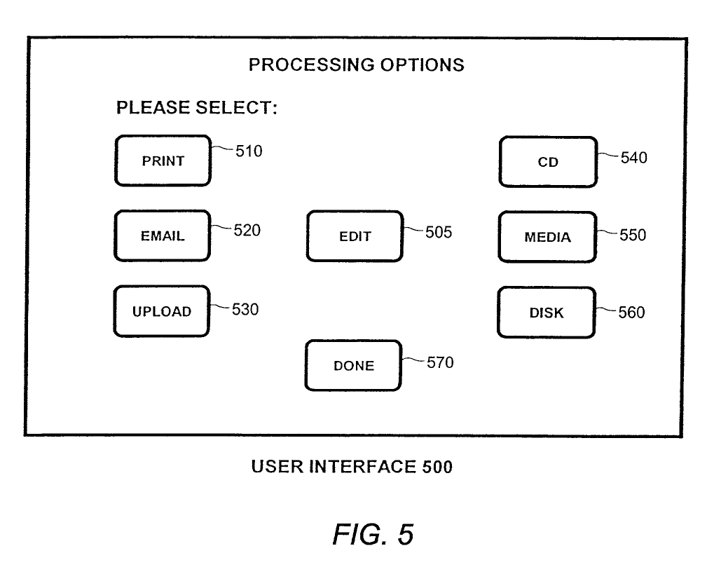

The processing of the storage media will now be explained in greater detail with reference to FIG. 5. Upon return of a rented storage media by a customer, the media is inserted into media processor 80. Media processor 80 has the capabilities to read and write to the storage media. At this point, user interface (UI) 500 appears on monitor 20. UI 500 depicts examples of processing services available to the customer upon return of the storage media. UI 500 may be a part of store UI 300, but need not be. For example, UI 500 may be displayed on a photo kiosk, or other user terminal, available for use by a customer and located in a rental location.

Using keyboard 30 or mouse 40, the returning customer can select what services they desire to have performed. In the alternative, UI 500 might be displayed on a touch screen whereby the customer could touch an icon associated with the desired function. The various functions available to the customer will now be described.

Option 505 allows the customer to perform editing processes on the data stored in the storage media. When option 505 is selected, an editing application stored on hard disk 175 may be launched allowing the customer to edit the stored data prior to further processing. For example, in the case of image data stored on the storage media by a digital camera, an image editing application may be launched. The customer could then perform photo editing services such as cropping, zooming, red-eye removal, image rotation, etc. on the image data.

When option 510 is selected, the data stored on the storage media is sent to printer 70 via PC 10. The data is then printed out and provided to the customer. Prior to printing, the customer may opt to perform editing functions on the data using option 505. In addition, the customer may be prompted to select print options such as the number, size and quality of the prints to be made.

When option 520 is selected, the customer is prompted for a single or multiple email addresses. Some portion or all of the data stored on the returned storage media may be emailed to the address or addresses provided by the customer. When option 530 is selected, the data is uploaded from the storage media and stored on server 90, or some other server accessible via network 95. The customer may then access the data over network 95 from another computer. The customer may be provided with an access code upon return of the storage media, or the customer could access the data using information stored in their customer profile.

Finally, options 540, 550 and 560 allow for transferring the stored data to a medium other than the returned storage media. The examples illustrated in FIG. 5 are a CD-ROM, customer-supplied media, or a floppy disk. It should be apparent that any type of removable storage media may be used including, but not limited to, DVD-ROM, Iomega's ZIP disk, compact flash card, smartMedia, Sony's Memory Stick, etc. When option 540 is selected, the stored data is written to a CD using CD drive 60 in PC 10. The customer is then given the CD containing the data, thereby allowing the customer to access the data from a computer with a CD drive. When option 550 is selected, the customer would provide storage media for data transfer, including, but not limited to, compact flash card, smartMedia, Sony's Memory Stick, etc. The data from the returned storage media may be transferred to hard disk 175 in PC 10, and to the user supplied storage media inserted in media processor 80. Finally, if option 560 is selected, the data contained on the storage media is transferred to a floppy disk via floppy disk drive 50 in PC 10. The customer then takes the floppy disk with him to access on other computers.

The above list of processing services available to the customer upon return is not exhaustive. Services may be added or removed depending on the needs of the system.

When the customer has finished selecting processing services, option 570 is selected to indicate the customer is finished. At this time the storage media is erased so as to prevent a later customer from having access to the images stored on a previously rented storage media. Any of a number of well known techniques for erasing the media may be used. Such techniques may involve writing bits of data over the stored data so as to wipe the stored data from the rented storage media. The techniques might range from a simple write-over technique to a full scale Department of Defense level erase.

If the media processor 80 and UI 500 are located in a photo kiosk or another type of terminal accessible to the renting customer, as suggested above, the customer can perform the above operations prior to returning the storage media to the rental location. Alternatively, the customer may not be done with the rental of the storage media, and may have stopped by the photo kiosk to obtain prints of the data stored on the storage media. In this case, when option 570 is selected, the customer may be prompted to select whether the erase function described above is performed at this time. The customer can thereby elect to keep their data on the storage media for future use, or the customer can elect to remove their data from the storage media before the storage media is returned. Accordingly, the customer can ensure that no employee will have access to the data contained on the storage media upon return of the storage media.

Once the storage media has been erased, the storage media's functionality is verified. This verification may occur on a variety of levels. For example, PC 10 may just try to write and read data on the storage media using media processor 80. Another alternative is to keep record of an estimated number of cycles the storage media has been used based on frequency and duration of rentals, and then comparing that number with an estimated lifetime for the particular type of storage media. Once a storage media has exceeded a certain number of cycles, it would be removed from circulation. This usage record could be included in the storage media's profile stored in inventory database 310. A third method implements test equipment similar to that used in testing newly manufactured storage media in media processor 80. The test is carried out upon each return of storage media to ensure functionality of the media.

Once the data stored on storage media is processed and erased, and the functionality of the storage media is verified using one of the methods mentioned above, the storage media may be entered back into inventory database 310 as shown in step S460 of FIG. 4.

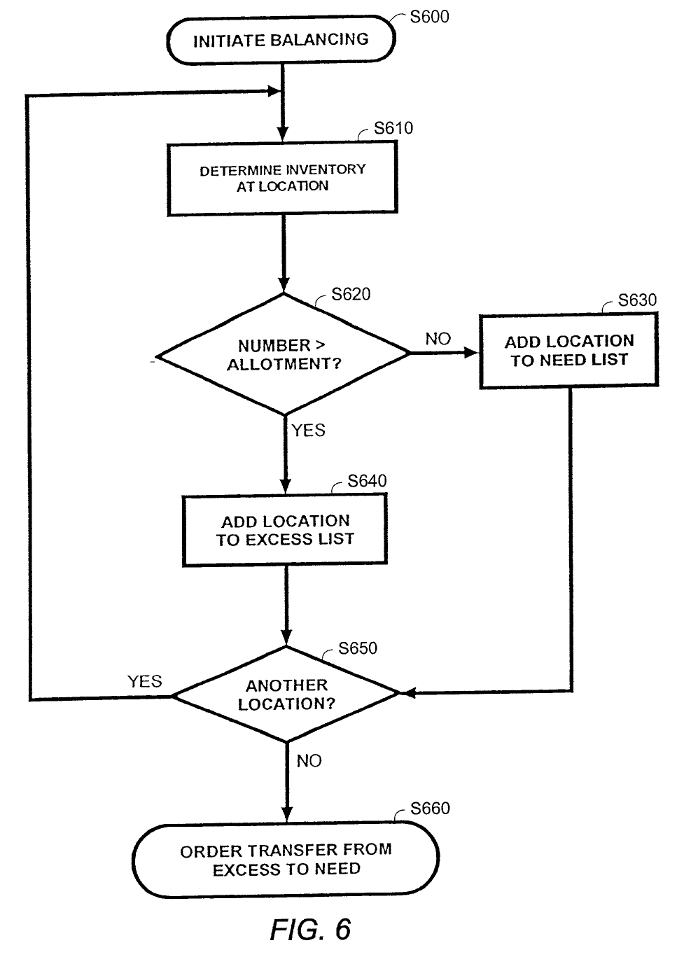

Finally, the functioning of inventory balancing director (IBD) 360 will be explained referring to FIG. 6. In step S600, IBD 360 is initiated. Step S600 may occur at regularly scheduled intervals or at the request of a rental location using store UI 300.

In step S610, IBD 360 refers to inventory database 310 of a rental location to determine the number of storage media available for rental at the rental location. In the alternative, if global inventory database 325 is used instead of inventory database 310, IBD 360 can refer to global inventory database 325 to determine the number of storage media at each rental location.

In step S620, IBD 360 compares the number of available storage media to a predetermined allotment number. An allotment number may be the same or different for each rental location and may be set in a number of ways. For example, average rentals over a period of time for each rental location may be used to set an allotment number in order to ensure availability of storage media in rental locations where they are needed the most. Alternatively, the allotment numbers may be determined solely by dividing up the total number of available storage media at the time by the number of rental locations.

If the available number for a particular rental location is below that location's allotment number, the rental location is placed on a need list in step S630. If the rental location has a number of available storage media in excess of their allotment number, the rental location is placed on an excess list in step S640. In step S650, it is determined whether there is another rental location whose number of storage media has not yet been determined. If another rental location remains, the process returns to step S610. The process of steps S610 through step S650 repeats until all rental locations associated with a rental system have had their available storage media determined. Once all rental locations have had their available storage media determined, the process proceeds to step S660.

In step S660, IBD 360 sends an order to transfer storage media from those rental locations listed on the excess list in step S640 to those rental locations listed on the need list in step S630. The details of a transfer, such as specific rental locations or quantities of storage media to be transferred, may be determined by an employee or manager of a rental system after reviewing the lists generated by the balancing process. In the alternative, the details of a transfer may be automatically set based on a predetermined formula or rotation that is performed by server 90 or PC 10 located at a rental location.

Since storage media may be rented at one rental location and returned to a different rental location, inventory balancing may advantageously be used to maintain inventory in all of the rental locations. Inventory balancing may further be used to accommodate demand at a rental location.

The invention has been described with respect to particular illustrative embodiments. However, it is to be understood that the invention is not limited to the above-described embodiments and that various changes and modifications may be made by those of ordinary skill in the art without departing from the spirit and the scope of the invention.

What is claimed is:

1. A method of renting removable digital storage media for use with a digital image acquisition device, the method comprising the steps of:
loaning removable digital storage media to a customer for storing digital image data captured by a digital image acquisition device;
receiving, upon return, the removable digital storage media from the customer; and
maintaining information associated with the loan and return of the removable digital storage media and the customer.

2. A method of renting removable digital storage media for use with a digital image acquisition device according to claim 1, wherein the removable digital storage media is lent at a first rental location and received at a second rental location.

3. A method of renting removable digital storage media for use with a digital image acquisition device according to claim 2, wherein the first rental location and the second rental location are the same location.

4. A method of renting removable digital storage media for use with a digital image acquisition device according to claim 2, wherein the first rental location and the second rental location are different locations.

5. A method of renting removable digital storage media for use with a digital image acquisition device according to claim 2, wherein the removable digital storage media is associated with an identification code.

6. A method of renting removable digital storage media for use with a digital image acquisition device according to claim 5, wherein the identification code associated with the removable digital storage media is securely stored on the removable digital storage media.

7. A method of renting removable digital storage media for use with a digital image acquisition device according to claim 5, wherein the maintaining step further comprises assigning the identification code to the removable digital storage media.

8. A method of renting removable digital storage media for use with a digital image acquisition device according to claim 5, wherein the maintaining step further comprises:
assigning an identification code to the customer;
associating the identification code of the removable digital storage media with the identification code of the customer when the customer is lent the removable digital storage media; and
disassociating the identification code of the removable digital storage media and the identification code of the customer when the removable digital storage media is received from the customer.

9. A method of renting removable digital storage media for use with a digital image acquisition device according to claim 5, wherein the maintaining step further comprises:
removing the identification code of the removable digital storage media from inventory of the first rental location when the removable digital storage media is lent by the first rental location to the customer; and
adding the identification code of the removable digital storage media to inventory of the second rental location when the removable digital storage device is received by the second rental location.

10. A method of renting removable digital storage media for use with a digital image acquisition device according to claim 9, wherein information associated with the inventories of the first and second rental locations is stored in a data store which is accessible by any of a plurality of rental locations.

11. A method of renting removable digital storage media for use with a digital image acquisition device according to claim 10, wherein the maintaining step further comprises the steps of:
assigning an identification code to each of a plurality of rental locations;
associating the identification code of a removable digital storage media with the identification code of a rental location when the rental location receives the removable digital storage media; and
disassociating the identification code of a removable digital storage media from the identification code of a rental location when the rental location lends the removable digital storage media.

12. A method of renting removable digital storage media for use with a digital image acquisition device according to claim 11, further comprising balancing the inventory of the first and second rental locations.

13. A method of renting removable digital storage media for use with a digital image acquisition device according to claim 12, the balancing step further comprising the steps of:
determining a number of removable digital storage media located at each of the first and second rental locations; and
transferring removable digital storage media from the first rental location to the second rental location when it is determined that the first rental location has an excess number of removable digital storage media and the second rental location has a deficient number of removable digital storage media.

14. A method of renting removable digital storage media for use with a digital image acquisition device according to claim 13, the balancing step further comprising requesting a transfer of removable digital storage media from a first rental location by a second rental location when it is determined that the second rental location has a deficient number of removable digital storage media.

15. A method of renting removable digital storage media, the method comprising the steps of:
loaning removable digital storage media to a customer for storing digital data;
receiving, upon return, the removable digital storage media from the customer;
processing the digital data stored on the returned removable digital storage media; and
maintaining information associated with the loan and return of the removable digital storage media and information associated with the customer.

16. A method of renting removable digital storage media according to claim 15, wherein the processing step further comprises making the digital data contained on the received removable digital storage media available to the customer.

17. A method of renting removable digital storage media for use in a digital image acquisition device according to claim 16, wherein the processing step further comprises the steps of:
transferring the digital data contained on the removable digital storage media received from the customer to another digital storage media; and
providing the other digital storage media containing the transferred data to the customer.

18. A method of renting removable digital storage media for use in a digital image acquisition device according to claim 16, wherein the processing step further comprises the steps of:
uploading the digital data contained on the removable digital storage media received from the customer to a computer server; and
providing the customer with access to the computer server.

19. A method of renting removable digital storage media for use in a digital image acquisition device according to claim 16, wherein the processing step further comprises emailing the digital data contained on the removable digital storage media received from the customer to one or more email accounts specified by the customer.

20. A method of renting removable digital storage media for use in a digital image acquisition device according to claim 16, wherein the processing step further comprises printing the digital data contained on the removable digital storage media received from the customer using an image forming apparatus.

21. A method of renting removable digital storage media according to claim 15, wherein the processing step further comprises the step of erasing the digital data contained on the received removable digital storage media.

22. A method of renting removable digital storage media according to claim 15, wherein the processing step further comprises the step of verifying the functionality of the received removable digital storage media.

23. A system for renting removable digital storage media at a first rental location to a customer for storing digital image data captured by a digital image acquisition device and receiving, upon return, the removable digital storage media at a second rental location from the customer, the system comprising a maintenance system for maintaining information associated with the rental and return of the removable digital storage media and the customer.

24. A system for renting removable digital storage media according to claim 23, wherein the removable digital storage media is associated with an identification code.

25. A system for renting removable digital storage media according to claim 24, wherein the identification code associated with the removable digital storage media is securely stored on the removable digital storage media.

26. A system for renting removable digital storage media according to claim 24, wherein the maintenance system further assigns the identification code to the removable digital storage media.

27. A system for renting removable digital storage media according to claim 24, wherein the maintenance system further comprises:
an assignment system that assigns an identification code to the customer; and
an association system that associates the identification code of the removable digital storage media with the identification code of the customer when the customer is lent the removable digital storage media, and disassociates the identification code of the removable digital storage media and the identification code of the customer when the removable digital storage media is received from the customer.

28. A system for renting removable digital storage media according to claim 23, wherein the maintenance system further comprises an inventory system that removes the identification code of the removable digital storage media from inventory of the first rental location when the removable digital storage media is lent by the first rental location to the customer and adds the identification code of the removable digital storage media to inventory of the second rental location when the removable digital storage device is received by the second rental location.

29. A system for renting removable digital storage media according to claim 28, wherein information associated with the inventories of the first and second rental locations is stored in a data store which is accessible by any of a plurality of rental locations.

30. A system for renting removable digital storage media according to claim 29, wherein the maintenance system further comprises:
an assignment system that assigns an identification code to each of a plurality of rental locations; and
an association system that associates the identification code of a removable digital storage media with the identification code of a rental location when the rental location receives the removable digital storage media and disassociates the identification code of a removable digital storage media from the identification code of a rental location when the rental location lends the removable digital storage media.

31. A system for renting removable digital storage media according to claim 30, further comprising a balancing system for balancing the inventory of the first and second rental locations.

32. A system for renting removable digital storage media according to claim 31, the balancing system further comprising:
a determination system that determines a number of removable digital storage media located at each of the first and second rental locations; and
a transferring system that transfers removable digital storage media from the first rental location to the second rental location when it is determined that the first rental location has an excess number of removable digital storage media and the second rental location has a deficient number of removable digital storage media.

33. A system for renting removable digital storage media according to claim 32, the balancing system further comprising a requesting system for requesting a transfer of removable digital storage media from a first rental location by a second rental location when it is determined that the second rental location has a deficient number of removable digital storage media.

34. A system for renting removable digital storage media to a customer for storing digital data and receiving, upon return, the removable digital storage media from the customer, the system comprising:
a processing system that processes the digital data stored on the returned removable digital storage media; and
a maintenance system that maintains information associated with the loan and return of the removable digital storage media and information associated with the customer.

35. A system for renting removable digital storage media according to claim 34, wherein the processing system further comprises a producing system for making the digital data contained on the received removable digital storage media available to the customer.

36. A system for renting removable digital storage media for use in a digital image acquisition device according to claim 35, wherein the processing system further comprises:
a transfer system that transfers the digital data contained on the removable digital storage media received from the customer to another digital storage media; and
a provision system that provides the other digital storage media containing the transferred data to the customer.

37. A system for renting removable digital storage media for use in a digital image acquisition device according to claim 35, wherein the processing system further comprises:
an upload system that uploads the digital data contained on the removable digital storage media received from the customer to a computer server; and
a provision system that provides the customer with access to the computer server.

38. A system for renting removable digital storage media for use in a digital image acquisition device according to claim 35, wherein the processing system further comprises an email system that emails the digital data contained on the removable digital storage media received from the customer to one or more email accounts specified by the customer.

39. A system for renting removable digital storage media for use in a digital image acquisition device according to claim 35, wherein the processing system further comprises a print system that prints the digital data contained on the removable digital storage media received from the customer.

40. A system for renting removable digital storage media according to claim 34, wherein the processing system further comprises an erasure system that erases the digital data contained on the received removable digital storage media.

41. A system for renting removable digital storage media according to claim 34, wherein the processing system further comprises a verification system that verifies the functionality of the received removable digital storage media.

42. Computer-executable process steps stored on a computer-readable medium, the computer-executable process steps to rent removable digital storage media to a customer for storing digital image data captured by a digital image acquisition device and to receive, upon return, the removable digital storage media from the customer, the computer-executable process steps comprising code to maintain information associated with the loan and return of the removable digital storage media and the customer.

43. Computer-executable process steps according to claim 42, wherein the removable digital storage media is associated with an identification code.

44. Computer-executable process steps according to claim 43, wherein the identification code associated with the removable digital storage media is securely stored on the removable digital storage media.

45. Computer-executable process steps according to claim 43, wherein the code to maintain further comprises code to assign an identification code to the removable digital storage media.

46. Computer-executable process steps according to claim 43, the code to maintain further comprising:
code to assign an identification code to the customer;
code to associate the identification code of the removable digital storage media with the identification code of the customer when the customer is lent the removable digital storage media; and
code to disassociate the identification code of the removable digital storage media and the identification code of the customer when the removable digital storage media is received from the customer.

47. Computer-executable process steps according to claim 46, the code to maintain further comprising:
code to remove the identification code of the removable digital storage media from inventory of a first rental location when the removable digital storage media is lent by the first rental location to the customer; and
code to add the identification code of the removable digital storage media to inventory of a second rental location when the removable digital storage device is received by the second rental location.

48. Computer-executable process steps according to claim 47, the code to maintain further comprising:
code to assign an identification code to each of a plurality of rental locations;
code to associate the identification code of a removable digital storage media with the identification code of a rental location when the rental location receives the removable digital storage media; and
code to disassociate the identification code of a removable digital storage media from the identification code of a rental location when the rental location lends the removable digital storage media.

49. Computer-executable process steps according to claim 48, the code to maintain further comprising code to balance the inventory of the first and second rental locations.

50. Computer-executable process steps according to claim 49, the code to balance further comprising:
code to determine a number of removable digital storage media located at each of the first and second rental locations; and
code to transfer removable digital storage media from the first rental location to the second rental location when it is determined that the first rental location has an excess number of removable digital storage media and the second rental location has a deficient number of removable digital storage media.

51. Computer-executable process steps according to claim 50, the code to maintain further comprising code to request a transfer of removable digital storage media from a first rental location by a second rental location when it is determined that the second rental location has a deficient number of removable digital storage media.

52. Computer-executable process steps stored on a computer-readable medium, the computer-executable process steps to rent removable digital storage media to a customer for storing digital data and to receive, upon return, the removable digital storage media from the customer, the computer-executable process steps comprising:
code to process the digital data stored on the returned removable digital storage media; and
code to maintain information associated with the loan and return of the removable digital storage media and information associated with the customer.

53. Computer-executable process steps according to claim 52, wherein the code to process further comprises code to make the digital data contained on the received removable digital storage media available to the customer.

54. Computer-executable process steps according to claim 53, wherein the code to process further comprises:
code to transfer the digital data contained on the removable digital storage media received from the customer to another digital storage media; and
code to provide the other digital storage media containing the transferred data to the customer.

55. Computer-executable process steps according to claim 53, wherein the code to process further comprises:
code to upload the digital data contained on the removable digital storage media received from the customer to a computer server; and
code to provide the customer with access to the computer server.

56. Computer-executable process steps according to claim 53, wherein the code to process further comprises code to email the digital data contained on the removable digital storage media received from the customer to one or more email accounts specified by the customer.

57. Computer-executable process steps according to claim 53, wherein the code to process further comprises code to print the digital data contained on the removable digital storage media received from the customer.

58. Computer-executable process steps according to claim 52, wherein the code to process further comprises code to erase the digital data contained on the received removable digital storage media.

59. Computer-executable process steps according to claim 52, wherein the code to process further comprises code to verify the functionality of the received removable digital storage media.
